(19) United States
(12) Patent Application Publication
(10) Pub. No.: US 2009/0088565 A1
(43) Pub. Date: Apr. 2, 2009

(54) Method for chemically modifying polysaccharides

(75) Inventors: Georg Schick, Chester, VA (US); Matthias Pascaly, Munster (DE); Stefan Wildmoser, Reichertshausen (DE); Hans Wenk, Essen (DE); Kathrin John, Hamburg (DE); Hans-Jurgen Kohle, Mainhausen (DE)

Correspondence Address: LAW OFFICE OF MICHAEL A. SANZO, LLC, 15400 CALHOUN DR., SUITE 125, ROCKVILLE, MD, 20855, US

(73) Assignee: Evonik Degussa GmbH, Dusseldorf (DE)

(21) Appl. No.: 11/919,702

(22) PCT Filed: May 3, 2006
(86) PCT No.: PCT/EP2006/062020

§ 371 Date: May 22, 2008

(30) Foreign Application Priority Data
May 3, 2005 (DE) 102005020552.6

(51) Int. Cl. C08B 37/00

(52) U.S. Cl. 536/123.1; 536/124

(57) ABSTRACT

The invention relates to a method for chemically modifying polysaccharides with the aid of a mechanical device and of at least one modifying reagent. The method is characterized in that the polysaccharide constituent is subjected at least once to a treatment by a roll mill during which at least two adjacent and counter-rotating rolls rotate at different speeds, and the polysaccharide constituent is mixed with the modifying reagent before and/or during the mechanical treatment. During this method, typically pectins, carob seed grain, guar meal and alginates are used as the polysaccharide constituent, and epoxides, amines or carboxylic acid derivatives are used as modifying reagents. The mechanical treatment can be repeated one to three times in a multiple roll mill, preferred rotating speeds of the adjacent rolls typically differing by 200%. The polysaccharides, which are mechanically modified in an extremely homogeneous manner according to the inventive method, are preferably used as thickening agents, gelling agents, emulsifiers, food additives, cosmetic additives, as well as hair and fiber care agents.

The present invention relates to a method for chemically modifying polysaccharides with the aid of a mechanical device and at least one modifying reagent.

Chemically modified polysaccharides are used widely in highly diverse areas. The best known fields of application are as thickeners, emulsifiers, foam stabilizers, dispersants, adhesives, sizes, flocculants, hair conditioners, building material additives and sorbents.

The aim of modifying polysaccharides consists, for example, in an improvement of the solubility in general and in particular in an increased alcohol solubility. However, the emulsifying properties of the polysaccharides can also be improved, and/or their thermostability can be increased; the introduction of chelating or charged groups may also be an interesting aspect of the chemical polysaccharide modification. However, graft polymerization can also produce polysaccharidic polymers with new properties.

In general, compared with purely synthetic polymers, chemically modified polysaccharides have the advantage that they are biodegradable, which, particularly in the development of new products, is ever more important.

A review of known reactions for chemically modifying polysaccharides is given by K. Engelskirchen (“Polysaccharid-Derivative” [Polysaccharide derivatives], in “Houben-Weyl, Methoden der Organischen Chemie”, Volume E20/Part 3 Makromolekulare Stoffe [Macromolecular substances], Georg Thieme Verlag 1987).

Known examples of derivatizations of polysaccharides which may be mentioned are the carboxymethylation of chloroacetic acid or chloroacetates and the methylation with methyl halides (cf.: D. Klemm et al., “Comprehensive Cellulose Chemistry Volume 2”, Wiley-VCH, 1998, pp. 221-234). However, the hydroxyethylation with ethylene oxide, the hydroxypropylation with propylene oxide (cf.: D. Klemm et al., “Comprehensive Cellulose Chemistry Volume 2”, Wiley-VCH, 1998, pp. 235-246), the amidation of pectins with ammonia or an ammonia solution and the esterification with the help of acids, anhydrides or acid chlorides is also widespread. Also in widespread use are the phosphating with orthophosphates, the ether formation with epoxides, organohalogen compounds, such as, for example, chlorohydrins or Michael acceptors, such as acrylic acid derivatives. The specified reactions can also be carried out in the presence of bases, acids or free-radical initiators which act as catalysts or reactants.

Also generally known is the hydrolytic, enzymatic, thermal or oxidative degradation of the polysaccharides to give products of reduced molecular weight or else reverse crosslinking, which leads to higher molecular weights.

The specified various reactions for chemically modifying polysaccharides are not restricted to certain representatives; instead, all known polysaccharides, such as, for example, pectins, alginates, carrageenans, galactomannans, such as carob seed flour or guar seed flour, starches and celluloses, are suitable. Further suitable substances are, for example, the polysaccharides listed by Pilnik et al. (“Polysaccharides”, in “Ullmanns Encyclopedia of Industrial Chemistry”, Vol. 19, Verlag Chemie Weinheim, 1980, pp. 233-263), which are considered to be part of this disclosure.

However, with all of the specified reactions, the low solubility and the marked viscosity-increasing properties of most polysaccharides prove to be disadvantageous, as a result of which chemical modification on an industrial scale is made more difficult. To overcome these problems, the reactions have to be carried out either in highly diluted solutions or in suspensions. Only for very few specific applications are solids reactions with pulverulent starting materials suitable.

U.S. Pat. No. 4,758,282 describes the so-called “dry” cationization of galactomannans, such as, for example, guar, with alkylidene epoxides and alkali metal or alkaline earth metal hydroxides in the presence of water and silicon dioxide. The technical aid used in this method is a plowshare mixer. A comparable derivatization of starch or starch-containing substances is described in U.S. Pat. No. 4,785,087. In this case too, recourse is made to a plowshare mixer as technical aid.

A solvent-free derivatization method for starch is described by Meuser et al. in Starch 1990, 42(9), pages 330 to 336. The method described here involves chemical modification in an extruder, where cationic starches and carboxymethyl starches are obtained. However, the use of an extruder is only useful to a very limited extent since, besides the very marked shear forces, high pressures and temperatures also arise which exclude the use of thermally sensitive modifying reagents and, moreover, can lead to degradation of the polysaccharide structure. This undesired secondary reaction is described in DE 4344156 A1 in connection with the production of depolymerized galactomannans.

If the reactions for the chemical modification are carried out in aqueous solutions, in most cases only very low degrees of substitution of the polysaccharides are achieved since most functional groups which are capable of reacting with polysaccharides also react with water. Solvents which would be able to dissolve polysaccharides, such as, for example, dimethyl sulfoxide, dimethylformamide, dimethyl-acetamide and pyridines, are mostly toxic, hazardous to the environment and/or technically problematic to handle. Furthermore, on account of the required high dilutions, very large amounts of solvent are required, which additionally renders the processes uneconomical.

On the other hand, reactions in suspensions or solids reactions exhibit advantages since these require much smaller amounts of solvents. In this case, the polysaccharide is not completely dissolved but, instead, through small amounts of solvents, a swelling of the solids particles is achieved, as a result of which diffusion of the subsequently added compounds into the polysaccharide particles is facilitated. However, it is disadvantageous here that the polysaccharide particles cannot be penetrated uniformly by the modifying reagent, for which reason homogeneously substituted products cannot be obtained with this process variant. Rather, the surface of the particles is significantly more highly modified than the inner areas, which is disadvantageous for the product properties and the reproducibility of the reaction overall. This problem occurs all the more so, the more hydrophobic the modifying reagent. A further aspect consists in the overall course of the reaction being greatly influenced by the particle size of the polysaccharide, as a result of which uniform reaction control is made more difficult.

In view of the described disadvantages of the prior art, the object for the present invention is to provide a method for chemically modifying polysaccharides which is carried out with the aid of a mechanical device and at least one modifying reagent. Using this novel method, a homogeneous and at the same time reproducible chemical modification should become possible although toxic and/or environmentally harmful solvents and auxiliaries should be largely dispensed with. A method is desirable which can be used as universally as possible for a broad spectrum of reaction types and which restricts the type of modifying reagents to be used as little as possible.

This object is achieved with a corresponding method which is characterized in that the polysaccharide component is subjected at least once to such a treatment with a roll mill that at least two adjacent and counter-rotating rolls rotate at different speeds and the polysaccharide component is mixed with the modifying reagent before and/or during the mechanical treatment.

Surprisingly, with this new method it was established that the desired chemical modification in the sense of a derivatization can be carried out extremely efficiently on very diverse polysaccharides, the modification range being additionally increased since the modifying reagents used are not subject to any restriction of any kind. Additionally, it was established that only very small amounts of liquid are required, where in particular water, being an ecologically and economically favorable solvent, can be used instead of the otherwise customary organic solvents. Of particular advantage is the method for hydrophobic and non-water-soluble modifying reagents which can thus, even in the presence of water, be homogeneously mixed and reacted with the polysaccharide component.

It was further surprising that despite the relatively high shear forces which arise as a result of the counter-rotating rolls, negative influences, as are known, for example, from extruders according to the prior art, do not arise. Rather, these high shear forces in the present case bring about an extremely homogeneous distribution of the reagents in the polysaccharide without this component being completely dissolved.

For the method according to the invention, it has proven advantageous to use a two-, three- or four-roll mill, while industrially a three-roll mill can be used particularly advantageously.

If, for reasons of cost or other reasons, a device with fewer rolls is available or adequate homogenization is not achieved in one treatment step, the mechanical treatment can of course also be repeated as often as desired. In this connection, the present invention envisages that, in particular, the mechanical treatment is repeated one to three times.

It is, inter alia, to be regarded as essential to the invention that adjacent rolls move countercurrently, and additionally have different rotation speeds. It is to be regarded as advisable if the rotation speeds of the adjacent rolls differ by 10 to 500%, with 100 to 300% being preferred and a rotation speed difference of 200% being particularly preferred.

As already indicated, the polysaccharide component is not subject to any limitations of any kind. For this reason, it can originate from all known starting materials, where representatives from the series pectin, galactomannans (in particular carob seed flour, guar seed flour, cassia, tara and tamarind galactomannan), alginates, carrageenans, xanthans, scleroglucans, starches, celluloses, gellans, pullulans, chitosans and any mixtures thereof are preferably used, which is likewise taken into consideration by the present invention.

In certain application cases of the claimed method, it may be favorable to carry out the mechanical processing and simultaneous chemical modification in the presence of at least one catalyst. For this case, a series of suitable compounds are available, preference being given to using bases, acids or free-radical initiators as are known from the prior art. The use amount here can be chosen relatively broadly, although a lower limit of 0.1% by weight and an upper limit of 30% by weight should be observed. The claimed method can be carried out particularly well if the catalyst content is between 0.5 and 10% by weight and in particular between 1.0 and 5.0% by weight, again based on the polysaccharide component.

The use of catalysts is required for certain modifying reactions, the type and amount of the catalyst being heavily dependent on the type of reaction.

Listed below are particularly suitable modifying reagents which can be used for the method according to the invention:

Epoxides, such as, for example, glycidol derivatives, epoxy-functionalized polysiloxanes, epoxy-functionalized quaternary ammonium compounds (e.g. 2,3-epoxypropyltrimethylammonium chloride, Quab® 151) and alkylene oxides react in the presence of basic catalysts with hydroxy groups of the polysaccharides to form ethers. Polysaccharides with carboxylic acid functions (such as, for example, alginates, low-esterification pectins and xanthans) react with epoxides even in the absence of catalysts to give carboxylic acid esters.

Also suitable for the etherification of polysaccharides are alkyl halides and derivatives, such as alkyl chlorides, chloroacetic acid and its salts, halohydrins, such as epichlorohydrin or 3-chloro-2-hydroxypropyltrimethyl-ammonium chloride (Quab® 188), mono- and dialkyl sulfates, also Michael acceptors, such as acrylic acid, acrylic acid esters, acrylamide, maleamide acids (e.g. N-octadecyl-maleamide acid), and esters or derivatives thereof. If appropriate, the use of catalytic or stoichiometric amounts of bases may be required here.

Carboxylic acids and derivatives thereof are likewise preferred modifying reagents which can be reacted with polysaccharides to form esters. Of suitability are primarily acid chlorides or anhydrides of fatty acids, maleic anhydride, succinic anhydride, acetic anhydride or acetyl chloride.

Pectins contain carboxylic acid methyl ester functions which can be functionalized with ammonia or primary or secondary alkyl- or arylamines to give amides. Besides ammonia or ammonia solutions, long-chain alkylamines, such as fatty amines, in particular are of interest.

It is of course also possible to use suitable mixtures of the specified reagents or comparable compounds provided these are compatible with one another and with the optionally used catalysts and reaction conditions.

The method according to the invention can be carried out particularly well when the modifying reagent is used in amounts of from 0.1 to 300% by weight, based on the polysaccharide component, where amounts between 1.0 and 150% by weight, in particular between 10 and 100% by weight and particularly preferably between 20 and 50% by weight are particularly suitable. The required amount of modifying reagent is of course dependent on the desired degree of substitution of the product and the reaction yield and selectivity of the modifying reaction, for which reason the suitable amount has to be determined in the individual case.

Although, surprisingly, it has emerged that the claimed method requires only minimal amounts of liquid, it may, however, be necessary, depending on the polysaccharide used and the particular modifying reagent, to add additional auxiliaries during the mechanical processing. A preferred representative of the additional auxiliaries which may be mentioned in the first instance is water; however, oils, alcohols, polyols, polyglycols, polyglycol ethers, borates and fumed or precipitated silicas can also be used. In this connection, amounts which are between 1 and 50% by weight, based on the polysaccharide component, have proven to be particularly favorable.

The quality of the chemical modification achieved with the method according to the invention can additionally be influenced through the choice of reaction temperature. The specified advantages of the method according to the invention become evident particularly when temperatures between 0 and 150° C. are chosen, the particular temperature being established by heating and/or cooling at least one roll. Alternatively or additionally, however, the reaction mixture can also be heated or cooled after the particular mechanical treatment, if appropriate also under superatmospheric pressure of from preferably 0 to 5 bar.

If required, an additional solvent can also of course be added, for which, on account of the chemical composition and structure of the starting material in particular, water has proven to be suitable. The additional amounts of solvent should preferably be below 70% by weight, where amounts of <50% by weight are regarded as being particularly preferred and amounts of <30% by weight are regarded as being especially preferred. The respective quantities of the additional solvent refer to the total reaction mixture.

Besides the described method, the present invention also claims the use of the modified polysaccharides produced by this method in a relatively broad application spectrum. Here, the use as thickener, gelling agent, emulsifier, food additive, as cosmetic additive, as building material additive, as hair-treatment or hair-aftertreatment composition or as laundry care composition is taken into consideration by the invention.

With the proposed method it is possible to chemically modify polysaccharides homogeneously in a simple way without negative effects arising, for example, from high temperatures and pressures. The shear forces likewise arising in the method according to the invention bring about homogeneous mixing, where they arise only for a short time and the heat which forms is very efficiently dissipated by the large roll surface. The simple and effective method is not restricted to certain polysaccharides and the method can easily be adapted to the particular application case through the selection of the process conditions and the addition of auxiliaries or acceptable solvents.

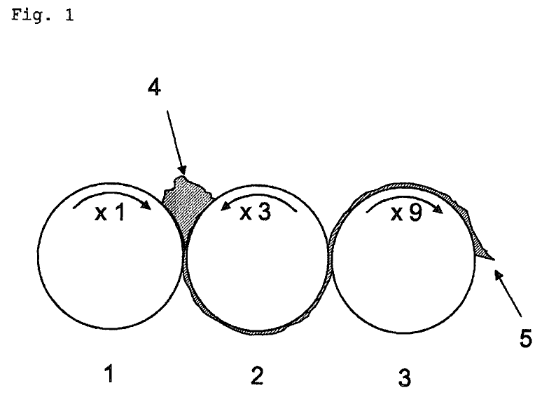

FIG. 1 illustrates the procedure of the claimed method. In the embodiment shown, modification takes place with three counter-rotating rolls (1, 2, 3), whose rotation speeds differ in each case by a factor of 3. A mixture of polysaccharide and modifying reagent (4) is applied between the first roll (1) and the second roll (2) and, after the mechanical treatment, is removed from the third roll (3) using a scraper (5).

The examples below illustrate the advantages of the method according to the invention.

### EXAMPLES

### Example 1

50 g of carob seed flour were mixed with a solution of 1.5 g of sodium hydroxide in 50 ml of distilled water and homogenized by passing twice over a three-roll mill. Each of the adjacent rolls differed in their rotation speed by 200%, the absolute speed being 0.14 m/sec for roll 1, 0.42 m/sec for roll 2 and 1.25 m/sec for roll 3. 20 g of a bis-epoxypolydimethylsiloxane were added and the mixture was again homogenized twice using the three-roll mill under identical conditions. The product was heated at 105° C. for 4 h in a sealed vessel, dispersed into 300 ml of 66% isopropanol using an ultra-turrax and adjusted to pH 7.0 using 10% HCl. The solid was filtered off with suction, washed with 300 ml of isopropanol and dried in a drying cabinet at 60° C. The degree of substitution was determined by means of NMR following hydrolysis with DCl/D₂O as 0.001 polydimethylsiloxane units per monosaccharide unit.

### Example 2

100 g of slow set pectin (DE 61.5) were coarsely mixed with a mixture of 43 ml of 25% ammonia solution, 70 ml of distilled water and 38 ml of isopropanol and homogenized at 10° C. using a three-roll mill. Each of the adjacent rolls differed in their rotation speed by 200%, the absolute speeds being 0.14 m/sec for roll 1, 0.42 m/sec for roll 2 and 1.25 m/sec for roll 3. The product was left to stand for 4 h, then taken up in 50% isopropanol, filtered with suction, washed with 300 ml of 50% isopropanol and dried. The product had a degree of amidation (DA) of 22 and a DE of 29.

### Example 3

40 g of hydroxypropylguar were mixed with a solution of 0.4 g of sodium hydroxide and 16 g of glycidyltrimethyl-ammonium chloride (70% solution in water) in 7 ml of water and passed over a three-roll mill. Each of the adjacent rolls differed in their rotation speed by 200%, the absolute speeds being 0.14 m/sec for roll 1, 0.42 m/sec for roll 2 and 1.25 m/sec for roll 3. The mixture was heated at 50° C. for 20 h, then suspended in isopropanol, neutralized with citric acid and the solid was filtered off with suction. The product was dried in a drying cabinet at 100° C. and ground. The degree of substitution of the product was 0.18 hydroxypropyltrimethylammonium groups per monosaccharide unit.

### Example 4

10 g of guar seed flour were mixed with a solution of 3 g of sodium hydroxide in 15 ml of distilled water and passed twice over a three-roll mill. Each of the adjacent rolls differed in their rotation speed by 200%, the absolute speeds being 0.14 m/sec for roll 1, 0.42 m/sec for roll 2 and 1.25 m/sec for roll 3. The resulting yellowish mass was stored for 1 h at room temperature, then admixed with 7.3 g of N-octadecylmaleamidic acid (HOOC—CH═CH—CONH—C₁₈H₃₇) and homogenized again twice over the three-roll mill under otherwise identical conditions. The product was heated at 60° C. for 4 h in a sealed vessel, taken up in 100 ml of 60% isopropanol, dispersed using an ultra-turrax and the suspension was adjusted to pH 7.0 with 10% HCl. The solid was filtered on a glass frit and dried in a drying cabinet at 60° C. The product had new strong IR absorptions at 1641 cm⁻¹ as well as at 2919 and 2849 cm⁻¹, characteristic of the C═O or C—H stretch vibrations, respectively, of the introduced substituents.

1-15. (canceled)

16. A method for chemically modifying a polysaccharide component with the aid of a mechanical device and at least one modifying reagent, said method comprising:
a) mechanically treating said polysaccharide component at least once with a roll mill, during which at least two adjacent and counter-rotating rolls rotate at different speeds; and
b) mixing said polysaccharide component with said modifying reagent before and/or during the mechanical treatment of step a).

17. The method of claim 16, wherein a two-, three- or four-roll mill is used.

18. The method of claim 16, wherein the mechanical treatment of step a) is repeated one to three times.

19. The method of claim 16, wherein the rotation speeds of the adjacent rolls differ by 10 to 500%.

20. The method of claim 16, wherein the rotation speeds of the adjacent rolls differ by 100 to 300%.

21. The method of 16, wherein said polysaccharide component is selected from the group consisting of: pectins; galactomannans; alginates; agar; carrageenans; xanthans; scleroglucans; starches; celluloses; gellans; pullulans; and chitosans; or mixtures of these compounds.

22. The method of claim 21, wherein said polysaccharide component is a galactomannan selected from the group consisting of: carob seed flour; guar seed flour; tara galactomannan; cassia galactomannan and tamarind galactomannan.

23. The method of claim 16, wherein said modifying reagent is selected from the group consisting of: epoxides; alkyl halides; chloroacetic acid; chloroacetates; halohydrins; mono- and dialkyl sulfates; ammonia; primary or secondary alkyl- or arylamines; acrylic acid; acrylic esters; acrylamide; maleamide acid derivatives; carboxylic acids; carbonyl chlorides; carboxylic anhydrides; and mixtures of these compounds.

24. The method of claim 21, wherein said modifying reagent is selected from the group consisting of: epoxides; alkyl halides; chloroacetic acid; chloroacetates; halohydrins; mono- and dialkyl sulfates; ammonia; primary or secondary alkyl- or arylamines; acrylic acid; acrylic esters; acrylamide; maleamide acid derivatives; carboxylic acids; carbonyl chlorides; carboxylic anhydrides; and mixtures of these compounds.

25. The method of claim 24, wherein said modifying reagent is used in an amount of from 0.1 to 300% by weight, based on the polysaccharide component.

26. The method of claim 16, wherein, during the mechanical treatment of said polysaccharide component, an auxiliary from the series water, oils, alcohols, polyols, polyglycols, polyglycol ethers, borates and fumed or precipitated silicas is added to said polysaccharide component.

27. The method of claim 26, wherein said auxiliary is used in an amount of from 1 to 50% by weight, based on the polysaccharide component.

28. The method of claim 16, wherein the mechanical treatment of said polysaccharide component is carried out in the presence of at least one catalyst, wherein the amount of catalyst is from 0.1 to 30% by weight.

29. The method of claim 28, wherein the amount of catalyst is from 1.0 to 5.0% by weight, based on the polysaccharide component.

30. The method of 28, wherein said polysaccharide component is selected from the group consisting of: pectins; galactomannans; alginates; agar; carrageenans; xanthans; scleroglucans; starches; celluloses; gellans; pullulans; and chitosans; or mixtures of these compounds.

31. The method of claim 30, wherein said modifying reagent is selected from the group consisting of: epoxides; alkyl halides; chloroacetic acid; chloroacetates; halohydrins; mono- and dialkyl sulfates; ammonia; primary or secondary alkyl- or arylamines; acrylic acid; acrylic esters; acrylamide; maleamide acid derivatives; carboxylic acids; carbonyl chlorides; carboxylic anhydrides; and mixtures of these compounds.

32. The method of claim 31, wherein said modifying reagent is used in an amount of from 0.1 to 300% by weight, based on the polysaccharide component.

33. The method of claim 32, wherein said catalyst is a base, acid or free-radical initiator.

34. The method of claim 16, wherein said method it is carried out at a temperature of from 0 to 150° C., wherein said temperature is adjusted by heating and/or cooling at least one roll and/or by heating or cooling the reaction mixture after the mechanical treatment.

35. The method of claim 16, wherein a solvent is additionally added to said polysaccharide component.

36. The method of claim 35, wherein said solvent is water and is used in an amount of less than 70% by weight.
